(19) United States
(12) Patent Application Publication
(10) Pub. No.: US 2026/0355931 A1
(43) Pub. Date: Nov. 12, 2026

(54) THROWABLE ROBOT WITH ENHANCED PERFORMANCE AND SURVIVABILITY

(71) Applicant: ReconRobotics, Inc., Edina, MN (US)

(72) Inventors: Alex J. Kossett, Minnetonka, MN (US); Andrew Drenner, Savage, MN (US)

(21) Appl. No.: 19/746,193

(22) Filed: Jul. 17, 2026

Related U.S. Application Data
(63) Continuation-in-part of application No. 18/402,629, filed on Jan. 2, 2024.
(60) Provisional application No. 63/436,818, filed on Jan. 3, 2023.
(60) Provisional application No. 63/845,963, filed on Jul. 17, 2025.

(51) Int. Cl. B25J 5/00; B25J 9/00; B25J 11/00; B25J 19/00

(52) U.S. Cl. CPC B25J 5/007; B25J 9/0009; B25J 11/002; B25J 19/005

(57) ABSTRACT

A two wheeled throwable robot comprises an elongate robot body with an axis supporting two drive wheels and a rearward tail extending from the robot body. The robot body comprising an elongate chassis with two ends, a motor at each end, the motors connecting to the drive wheels through gear and clutch systems supported by the chassis, sensors and operational components positioned at the front of the chassis, processing circuitry, radio, memory, power control circuitry are located in the chassis such as the circuitry compartments and may be sealingly contained therein. The chassis having a main chassis body that provides enhanced structural strength by supporting the drive motors in conforming bores and having a plurality of U-shaped recesses for receiving a forward chassis body component and a battery module. Additional recesses on the ends of the main body component, along with end chassis caps define drive system compartments for gear systems and clutch mechanism that are isolated from the interior circuitry compartments and the drive motors.

### CROSS-REFERENCE TO RELATED APPLICATIONS

This application claims priority to U.S. Provisional Application No. 63/845,963, filed Jul. 17, 2025, and is a continuation-in-part of U.S. Non-Provisional application Ser. No. 18/402,629, filed Jan. 2, 2025, which claims the benefit of U.S. Provisional Application No. 63/436,818, filed Jan. 3, 2023, all of which are herein incorporated by reference in their entireties for all purposes.

### BACKGROUND OF THE INVENTION

Throwable robots for use in military and police operations need to be highly durable and robust to reliably perform under difficult conditions. Additionally, such robots ideally have capabilities for mounting accessories and payloads, quick recharge of batteries, robust imaging capabilities, significant processing power. Any incremental improvements in reliability and performance for robots used in high stakes military and police operations are desirable. Ideally such robots can absorb substantial falls, and other shock conditions, moisture, and other contaminants.

### SUMMARY OF THE INVENTION

A two wheeled throwable robot comprises an elongate robot body with an axis supporting two drive wheels and a rearward tail extending from the robot body. The robot body having an upper recess for receiving a payload positionable intermediate ends of the body, the recess extending most of the axial length of the body. A payload may be conformingly shaped to attach to the body at the recess. When viewed from the front of the robot, the body defining the recess has a U-shape. The body comprising a chassis that has upwardly projection portions adjacent the wheels on each side of the recess. The recess in combination with a protective envelope defined by the wheels provides an enhanced and enlarged protected zone for accessories mounted to the robot at the recess.

A two wheeled throwable robot comprises an elongate robot body with an axis supporting two drive wheels and a rearward tail extending from the robot body. Axis of the drive wheels and body axis are coextensive or parallel and offset. The robot body comprising an elongate chassis with two ends, a motor at each end, the motors connecting to the drive wheels through gear and clutch systems supported by the chassis, sensors and operational components positioned at the front of the chassis, processing circuitry, radio, memory, power control circuitry are located in the chassis such as the circuitry compartments and may be sealingly contained therein.

The elongate chassis having end portions that have each have a generally cylindrical shape. The robot body axis is generally coextensive with the chassis axis. The chassis and providing a clearance between an exterior surface of the chassis and the exterior periphery of the drive wheels. The chassis being compartmentalized for isolating, structurally supporting, and protecting particularly componentry of the robot body while still providing serviceability and enhanced structural strength such as for absorbing shock from throws or other shock conditions. In embodiments, the chassis having an elongate payload recess on a top side of the chassis for receiving payloads such as accessories, an elongate battery module recess on the bottom side of the chassis, axial bores for receiving drive motors above the battery module recess, one or more forward circuitry compartments positioned behind forward portals for sensors and illumination, and drive system compartments on each lateral end of the chassis for gear and clutching systems. The compartments and recesses defined by a main chassis body and a forward chassis body, and two chassis end caps. The forward chassis body received by a forward facing recess on a forward side of the main chassis body, the one or more circuitry compartments defined by the main chassis body and forward chassis body. A seal or gasket may be positioned at the juncture between the forward chassis body and the main chassis body.

The payload recess extending substantially the axial length of the chassis, with the chassis having a pair of lateral end walls defining the payload recess. In embodiments, the payload recess being open upwardly, forwardly, and rearwardly, thereby maximizing the volumetric carrying capability of the robot. In embodiments, the chassis having one or more upwardly facing flat surfaces substantially defining the lower boundary of the recess. The robot having an electrical connector exposed upwardly on the chassis at the one or more flat surfaces for connecting with the payload and further having a plurality of threaded holes facing upwardly for attachment of payload or other accessories.

The elongate axially extending battery module recess open downwardly and rearwardly and positioned on a bottom side and rearward side of the chassis. The chassis having a pair of battery recess endwalls that define the lateral ends of the battery module recess. The battery module recess having a concave shape when viewed in cross section. An electrical battery connector is positioned on the chassis in the recess for connecting to the battery enclosure. When the battery module is connected to the robot in the battery module recess, the battery module seats in-between the pair of battery recess endwalls and a rearward side and a downward side of the battery module is exposed. The chassis having a plurality of threaded holes for attaching the battery module to the chassis with threaded fasteners. Two ends of the battery module engage and/or confront the respective battery recess endwalls of the chassis.

In embodiments, the chassis having a main chassis body and a forward chassis body that functions as a cover over one or more circuitry compartments and may further have compartment recesses partially defining the one or more circuitry compartments. The forward chassis body providing a plurality of front side chassis portals for forward directed sensors and operational components of the robot. Such sensors and operational components may be mounted on boards or brackets in the circuitry compartments to be positioned at or extend through the front portals of the chassis. The forward chassis body extending from the bottom side of the robot body to the top side and may partially define the flat surfaces on the top of the chassis that receive the payload and accessories. That is, a juncture between the forward chassis body and main chassis body may extend axially on the top side of the robot body substantially the axial length of the chassis. The lateral ends of the forward chassis body may be spaced inwardly from the lateral ends of the chassis and may further have a pair of radially extending walls partially defining the one or more circuitry compartments and providing an exterior axial facing surface to confront and or engage a pair of walls.

The main body portion of the chassis having a pair of axial end portions that define a pair of drive system compartments that sealingly contain a gear drive system and clutch system. The chassis may have walls with inward surfaces at the recess for receiving the forward chassis body. A pair of end caps extend over and further have recesses partially defining the drive system compartments. The endcaps may be sealingly attached with engaging or confronting cylindrical surfaces, engaging circular and axially facing surfaces and a plurality of threaded fasteners circularly spaced about a peripheries of the respective drive system compartments, clamping the circular and axially facing surfaces together. The drive system compartments may have a shape that is cylindrical with a portion that bulges radially outwardly for accommodating the drive gear connected to the drive motor. One or both of the pair of lateral endwalls that define the payload receiving recess may further be a wall partially defining the pair of drive system compartments. One or both of the pair of battery recess endwalls may also be a wall that partially defines the pair of drive system compartments.

The bores for the drive motors may be configured to conform to most of the external surface of the drive motor providing secure attachment within the robot body during impact. A feature and advantage of embodiments is that the bores for receiving the motor are in the main chassis body and are not located at a juncture of the main chassis body and forward chassis body. A feature and advantage is the most of the outer surface area of the cylindrical shaped drive motors confront and/or contact the conforming surface area of the bore in the chassis. The drive motors may each have a flange attached to the drive shaft end of the drive motor with screws and the flange may connect to the main chassis body at an aperture leading into the drive motor receiving bore of the chassis.

A feature and advantage of the throwable robot is that the main chassis body has three axially extending recesses for receiving 1) payload, 2) a battery module, and 3) the forward chassis body with portals. Each of the recesses having a U-shape when viewed in an axial cross section of a plane through the axis of the chassis or robot body. The recesses each spaced from the axial ends of the chassis. The battery module and forward chassis body each providing an exterior surface to the robot body that is generally cylindrical.

A feature and advantage of the throwable robot is that the main chassis body has axial end recesses that viewed in cross section at a plane through the chassis or body axis defines a U-shape facing axially outward. The end caps are received into the recesses such that impacts thereto are absorbed in the U-shape recesses and do not provide a shear force that urges component separation. The chassis end cap and the recess of the main chassis body providing a compartment that isolates the gearing and clutch mechanism from environmental contaminants and further isolates the circuitry compartment from the drive system compartments. The drive system compartment having the drive motor shaft entering it, the drive wheel axle exiting it, and it may otherwise be sealed.

A feature and advantage of the layout is the vulnerable PCB associated with circuitry is secured in compartments that provide a high level of containment integrity and a high level of structural strength. A feature and advantage of the chassis design is that impacts to the forward chassis body or to the battery module will typically be absorbed by the confronting surfaces of the forward chassis body and the main chassis body or the confronting surfaces of the battery module and main chassis body. That is such impacts do not impart meaningful shear separation forces that could cause failures at the juncture of the chassis components. Similarly, impacts on the ends of the robot impart shock forces to the chassis end caps which are received in the

A feature and advantage of embodiments of the invention over known art throwable robots is increased volume for the batteries and the batteries of the battery module may be readily swapped out with another battery module rather than needing to recharge the battery when the battery energy level is low. A feature and advantage is that the battery module shape and attachment arrangement provides increased structural strength to the robot body making the body less vulnerable to damage when thrown. A feature and advantage is that the battery module may take impact shocks and may be less vulnerable to damage compared to a conventional chassis and may be readily replaced if damaged.

A feature and advantage of embodiments of the invention over known throwable robots is a novel motor mounting system which can accommodate motors more securely and can readily accommodate motors with encoders.

A feature and advantage of embodiments of the robot may sustain impact shocks to the two drive wheels better than conventional two wheeled robots in that the axle connecting to each drive wheel is secured at two axially displaced locations in chassis bushings. One bushing in the main chassis body and one bushing in the chassis end cap. The main driven gear and clutch mechanism positioned on the axle in between the two bushings. The two bushings separated by at least 1 inch in embodiments. In embodiments, the two bushings separated by at least 1.5 inches. In embodiments the two bushings not separated by more than three inches.

A feature and advantage of embodiments of the invention over known throwable robots is an Integrated digital video—can be processed onboard, video overlays can be added

A feature and advantage of embodiments of the invention over known throwable robots is a significantly increased processing power (can now process video onboard, potential for increased autonomy).

A feature and advantage of embodiments of the invention over known throwable robots that contributes to the modularity, is that all major components connect through board to board connectors.

### BRIEF DESCRIPTION OF THE DRAWINGS

FIG. 1 is a rear perspective view of a throwable robot according to embodiments with accessories mounted on a top side recess.

FIG. 2 is a front perspective view of the throwable robot of FIG. 1.

FIG. 3 is a side perspective view of a robot with a mounting rail provided at the accessory mounting top recess.

FIG. 4 is a front perspective view of the robot of FIG. 3 with the rail removed illustrating the top side accessory recess.

FIG. 5 is a front perspective view of another throwable robot with wheels and a tail of reduced size compared to the robots of FIGS. 1-4.

FIG. 6 is a rear perspective view of the robot of FIG. 5 with the accessories removed and a rail for accessories mounted at the top side accessory recess.

FIG. 7A is a front elevational view of the main chassis component and the forward chassis component engaged therewith.

FIG. 7B is a perspective view of the main chassis component and the forward chassis component engaged therewith.

FIG. 7C is a cross sectional view of the main chassis component and the forward chassis component at line 7C-7C of FIG. 7A.

FIG. 8A is an exploded view of chassis components according to embodiments.

FIG. 8B is another exploded view of the chassis components of FIG. 8A.

FIG. 9 is a perspective view of a main chassis body component of the robots of FIGS. 1-6.

FIG. 10 is another perspective view of the main chassis body component of FIG. 9.

FIG. 11 is another perspective view of the main chassis body component of FIG. 9.

FIG. 12 is a cross sectional view of the main chassis body portion taken at plane 12-12.

FIG. 13 is a cross sectional view of the main chassis body portion taken at plane 13-13.

FIG. 14 is a cross sectional view of the main chassis body portion taken at plane 14-14.

FIG. 15 is a cross sectional view of the main chassis body portion taken at plane 15-15.

FIG. 16 is a perspective view of the internal componentry secured within the chassis of embodiments without the chassis.

FIG. 17 is another perspective view of the internal componentry of FIG. 16.

FIG. 18 is a rearward upwardly looking perspective of a robot illustrating the location of a battery module.

FIG. 19 is a rearward perspective view of the robot of FIG. 18 with the battery module separated from the chassis of the robot.

FIG. 20 is another view of the robot of FIG. 19 with the separated battery module.

FIG. 21 is a view of the robot of FIGS. 18-20 with a front chassis component removed from a U-shaped forward facing recess.

FIG. 22 is another view of the robot of FIG. 21 with the separated front chassis component.

FIG. 23 is another view of the robot of FIG. 21 with the separated front chassis component.

FIG. 24 is a view of the robot of FIG. 4 with the front chassis component separated.

FIG. 25 is a perspective view of the robot of FIG. 5 with the top side accessory package separated from the top side U-shaped recess.

FIG. 26 is another perspective view of the robot of FIG. 5 with the accessory package removed.

FIG. 27 is an exploded view of a drive system for a drive wheel of embodiments.

FIG. 28 is an exploded view of the drive system of claim 27 taken from the opposite side.

FIG. 29 is a view of the drive system of FIGS. 27 and 28 with the chassis removed illustrating the drive motor with encoder.

FIG. 30 is an exploded view of the drive system of FIG. 28 at a different view.

FIG. 31 is perspective view of a robot and protected payload region according to embodiments.

FIG. 32 is a side elevational view of a robot with a wheel removed illustrating the location of the protected payload region.

FIG. 33 is side elevational view of the protective zone illustrated in FIG. 31, the dimensions illustrated may vary, in embodiments.

FIG. 34 is rear elevational view of the protective zone illustrated in FIGS. 31 and 32, illustrating a cut out for the tail and having the shape of an inverted U.

FIG. 35 is a side transparent elevational view of an exemplary accessory conformingly shaped to the protective zone of FIGS. 31 and 32.

FIG. 36 is a top plan view of the accessory of FIG. 35 with connection means for attachment to the robot, the accessory conformingly shaped to the robot body recess and to the protective zone of FIGS. 31 and 32.

FIG. 37 is a front elevational view of the accessory of FIGS. 35 and 36.

FIG. 38 is a side elevational view of the accessory of FIGS. 35 and 36.

### DETAILED DESCRIPTION

Referring to FIGS. 1-4, a two wheeled throwable robot 40 comprises body 42 supporting a pair of drive wheels 44, 46 and with a tail 48 extending rearwardly from the body. The body comprises a chassis 50 that supports operational componentry for the driving, surveillance and other functionalities of the robot. The robot body 42 and chassis 50 generally have an axis α1. The robot, body, and chassis all generally have a top side 52, a bottom side 53, a front side 54, a rear side 55, a port side 56 and a starboard side 57.

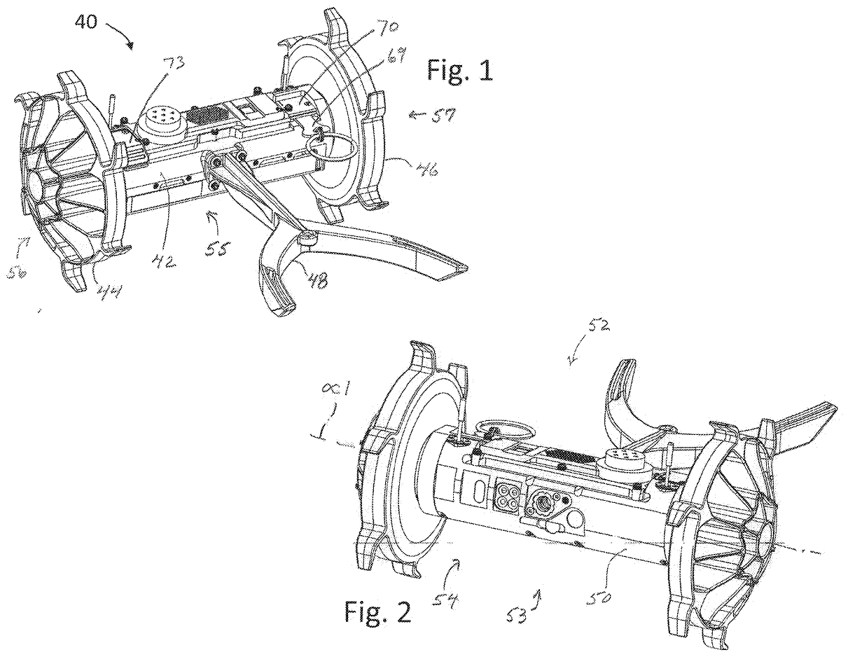

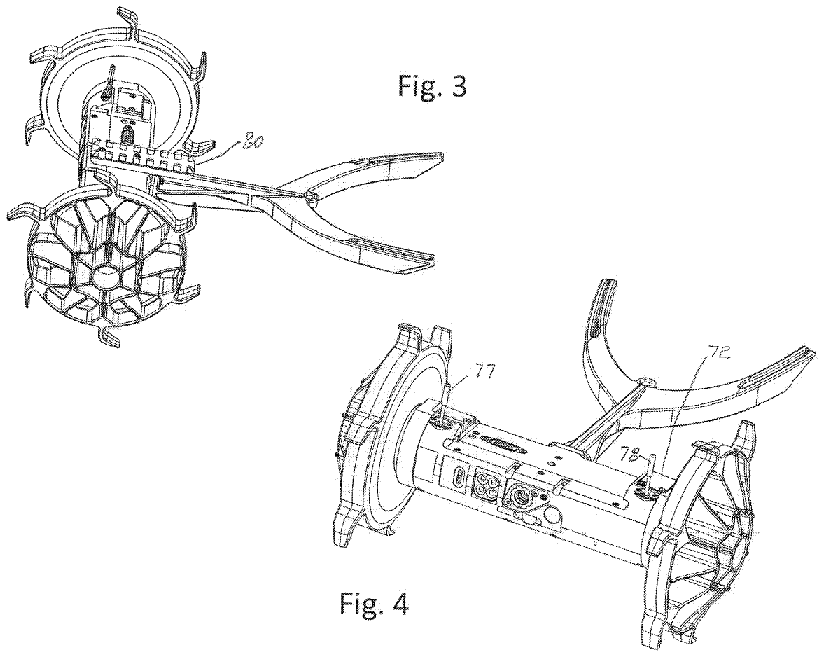

Exposed on the front side of the robot are a high definition 1080p camera 60, a thermal camera 62, IR and visible illumination source 64, and a passive IR sensor 65 for motion detection. On the top side, an accessor recess 67, best shown in FIG. 4, spans most of the distance between the drive wheels 44, 46 and an accessory package 68 shown in FIGS. 1 and 2 is attached to the robot at the accessory recess.

The accessories may include sensors, additional communication components, munitions, environmental sensing, environmental effecting components including munitions. Additional accessories and systems associated with the accessories, including mounting and protection components are disclosed in U.S. Pat. No. 11,479,102 and publication WO 2021/102060, both owned by the owner of the instant application, and both incorporated herein by reference for all purposes.

The top side may also include a pull to activate key 69 and key sensor 70, a USB connector 72 with a cover 73 (see FIG. 1), an electrical connector terminal 75 for the attached accessories, antennas 77, 78 for a radio(s). See US 2021/0362355 for details on suitable magnetic lock systems for throwable robots. The publication is incorporated herein by reference for all purposes.

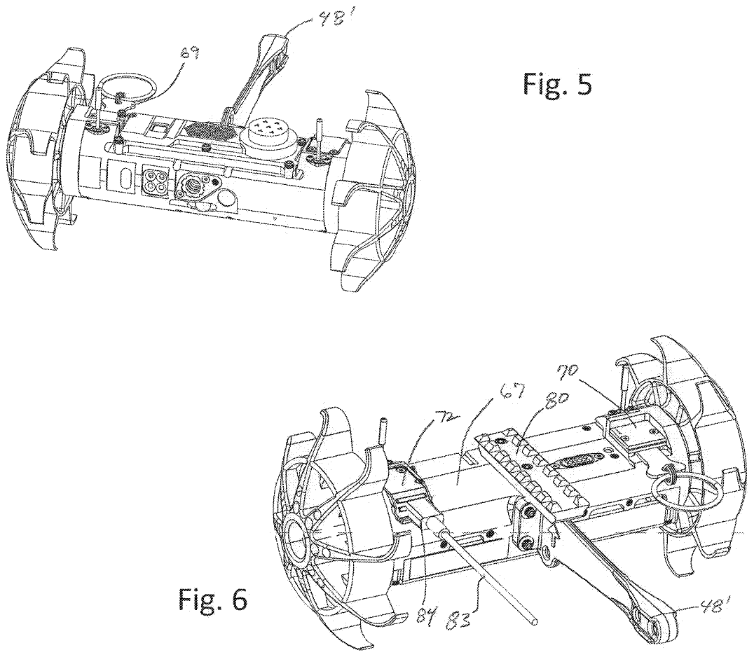

Referring to FIGS. 5 and 6, additional configurations of embodiments include robots with reduced diameter wheels 44′, 46′, and reduced sized of the robot tail 48′. FIG. 6 illustrates an accessory rail 80, such as a picatinny rail mounted in the accessory recess, and a connector cable 83 with a USB connector 84

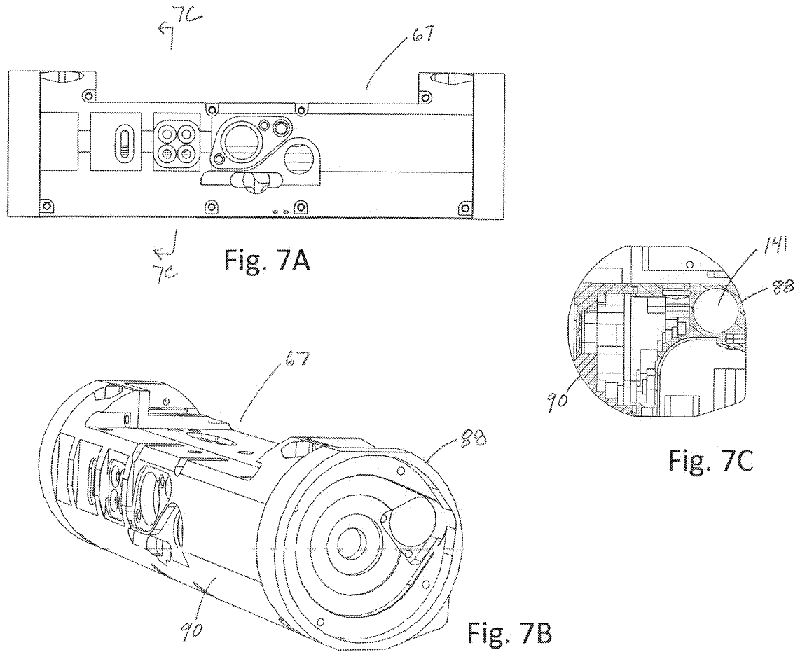

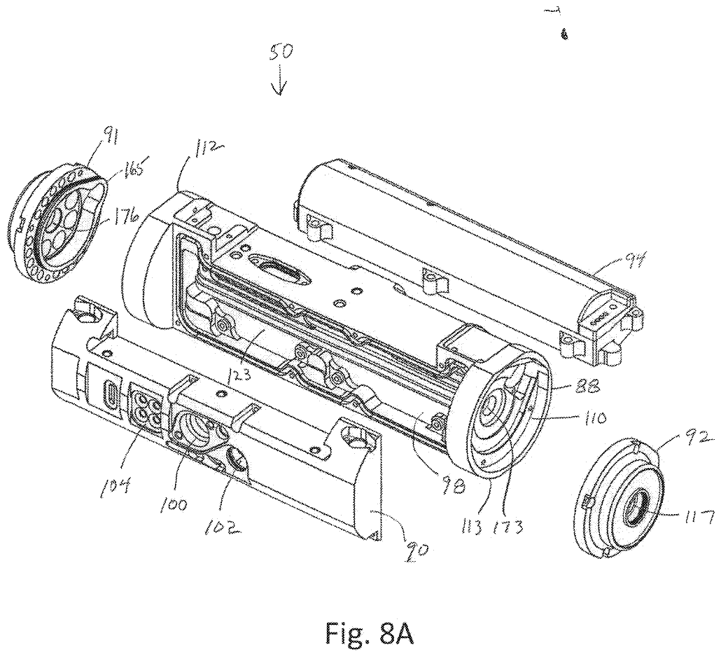

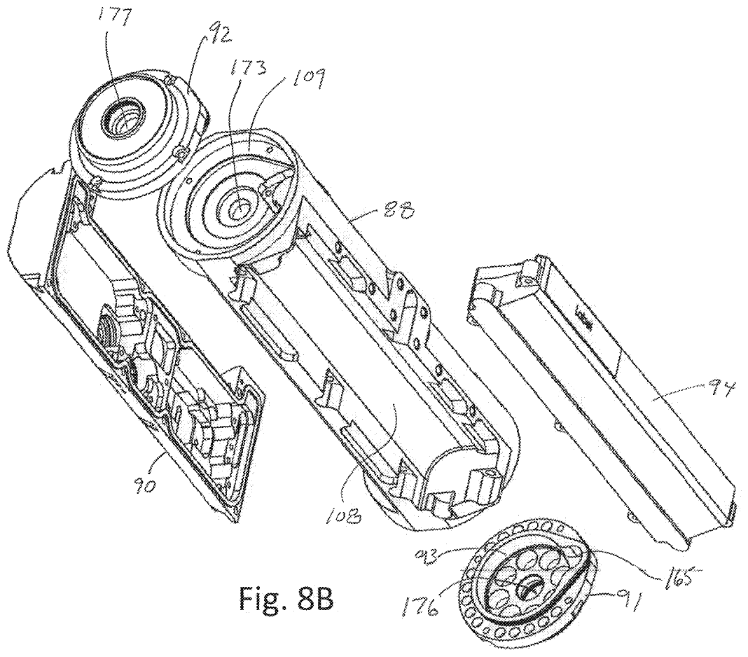

Referring to FIGS. 7A-11, components of chassis 50 are illustrated and include a main chassis body component 88, a forward chassis component 90, a pair of chassis end caps 91, 92 with recesses 93. Additionally a battery module 94 is secured to the chassis 50 and may define part of the chassis. The main chassis body component 88 defines several U-shaped recesses. “U-shaped” recesses meaning the structure defining the recess has outward facing surfaces that define a U when taken in a cross section along an axial length of the recess. The structure defining the recess will have a bottom surface and walls with surfaces extending at a perpendicular angle (or an angle of about 70 to 110 degrees) to the bottom surface.

Referring to FIGS. 1-7B and 25-26, the chassis and the main chassis body component 88 has a U-shaped top side accessory recess 67, a forward U-shaped recess 98 that receives circuitry and other components and also receives the forward chassis component 90. The forward chassis component 90 configured as a panel also has an upwardly facing recess that conforms to the main chassis body component recess and may have a seal or gasket 99 at the juncture of the main chassis body component and the forward chassis component. The forward chassis component having a plurality of portals 100, 102, 104 for the cameras 60, 62, illumination components 64, and IR sensor 65. A further U-shaped recess 108 is the recess for the battery module. The battery module recess 108 also has a U-shape in a cross section taken at a plane transverse to the axis of the chassis. The portals are suitable sealed by lenses or the actual sensor or other component exposed therethrough.

In embodiments the top side accessory recess extends inwardly from the outer periphery of the chassis more than 0.4 inches the entire length of the accessory recess. In embodiments, the top side recess extends inward less than 1.3 inches. In embodiments, the accessory recess extends inwardly more than 0.75 inches.

The main chassis body 88 also has a pair of inward and axially extending end recesses 109, 110 at each end 112, 113 of the component. These recesses have a U-shaped when viewed in a cross section. The end recesses 109, 110 along with the chassis end caps 91, 92 provide a containment or compartment that contain the gear system and clutch mechanism for the drive wheels and is substantially isolated therein.

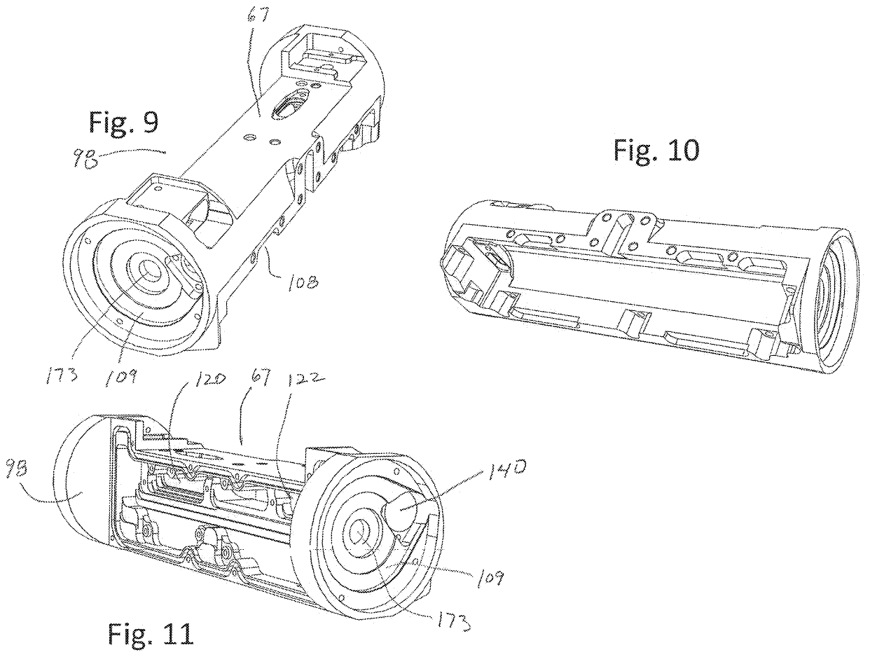

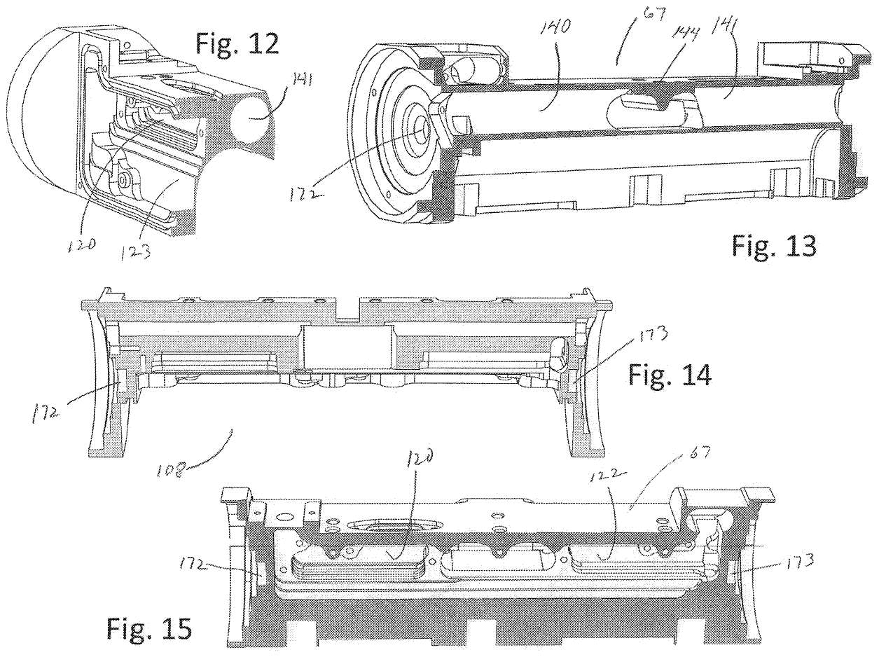

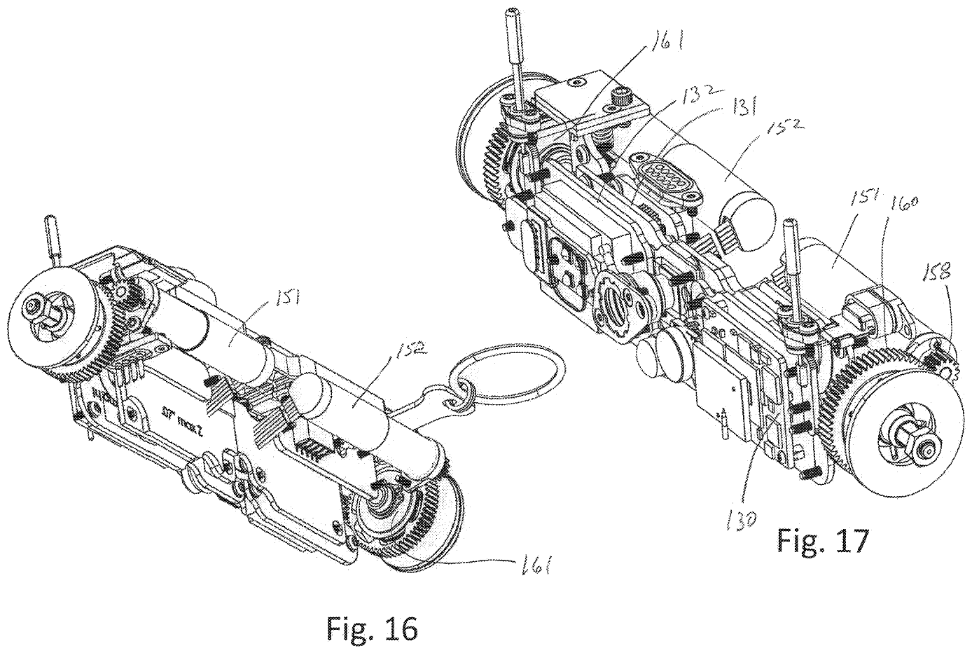

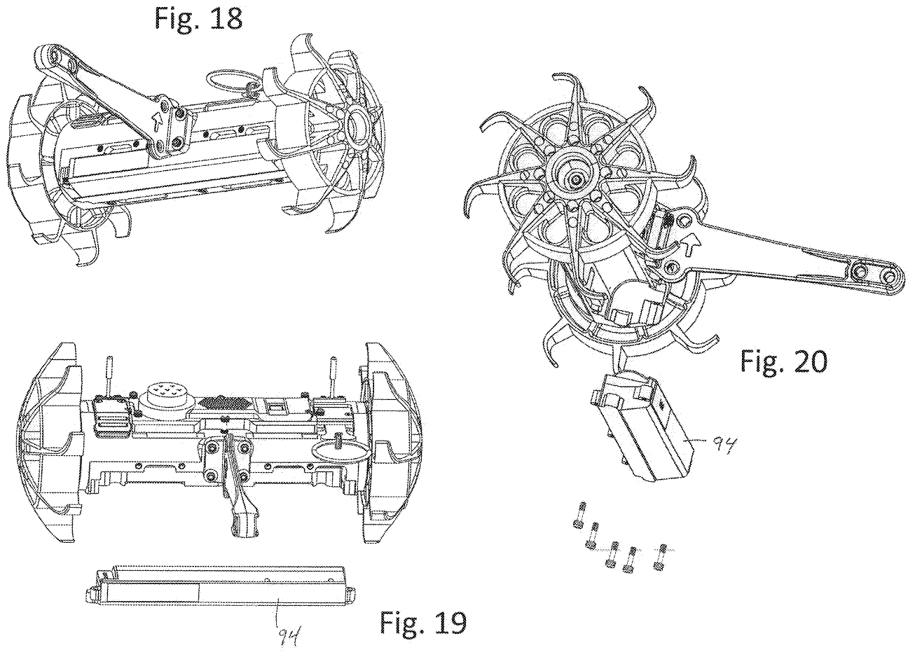

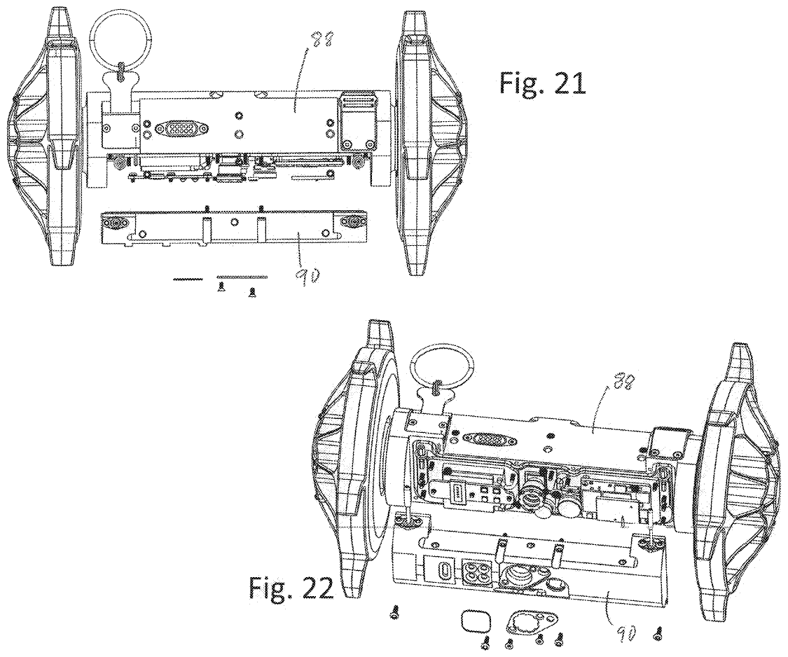

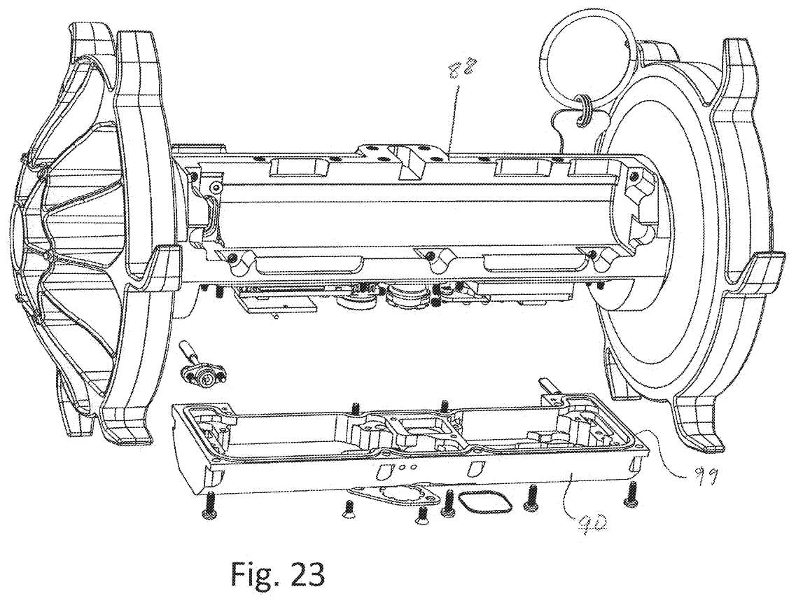

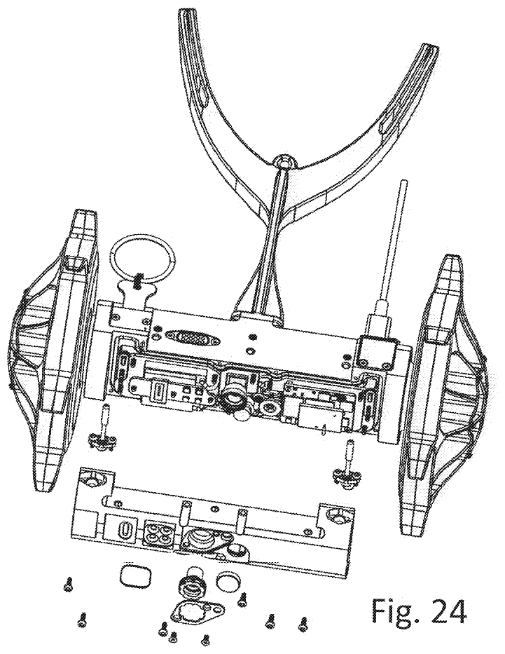

Referring to FIGS. 9-17 and 21-24, details of the support of the internal componentry by the chassis 50 are illustrated. The main chassis body 88 and forward chassis component 90 define a plurality of circuitry compartments 120, 122, 123 that receive circuity 125 that comprise printed circuit boards with componentry which may include processing circuity 130, power control/management circuitry 131, radio/communications circuitry 132, video processing circuitry, memory and the like. The processing may include artificial intelligence capabilities providing the robot with, for example, autonomous decision making and operating capabilities.

The main chassis body has two bores 140, 141 extending from the end recesses 109, 110 to the central portion 144 of the main chassis body. The bores are conformingly sized for the two drive motors 151, 152 that may include encoders. Motor flanges 154 may be attached to the drive shaft end of the motors with fasteners and the flange connected to the main chassis body at the aperture extending into the respective bore. The drive motors are connected to control circuitry and have an output shafts with a drive gear 158 thereon that is engaged with a larger driven gear 160 that is coupled through clutch mechanisms 161 to the respective drive wheels by axles 162. The clutch mechanism 161 and driven gear and axles 162 are supported by bushings 169 in the central recesses 172, 173 at the end portions 112, 113 of the main chassis body component 88 and bushings 174 the bore 176, 177 in the chassis end caps providing a high level of containment and strength. A thrust washer 181 may be positioned between the chassis end cap and the drive wheel. The thrust washer may be a polymeric material providing a low coefficient of friction and shock absorbing function. The central projecting part of the chassis end caps my extend into a central interior facing recess 184 of the drive wheels. The chassis end caps have an outer radial projecting portion 165 that may be bulbous and that provides a radial expansion of the recess 93 for accommodating the drive gear 158 engaged with the driven gear.

See U.S. Pat. Pub. No. US 2020/0282569 which is incorporated by reference for all purposes for further disclosure of drive systems including clutch mechanisms.

The main chassis body component being unitary and supporting the drive motors in the bores, rather than using brackets for example, and with the drive system supported by the drive system bores.

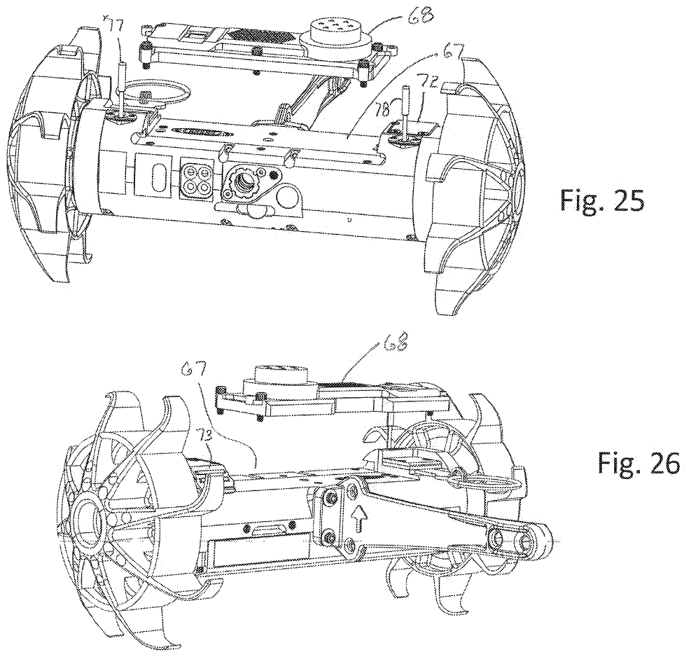

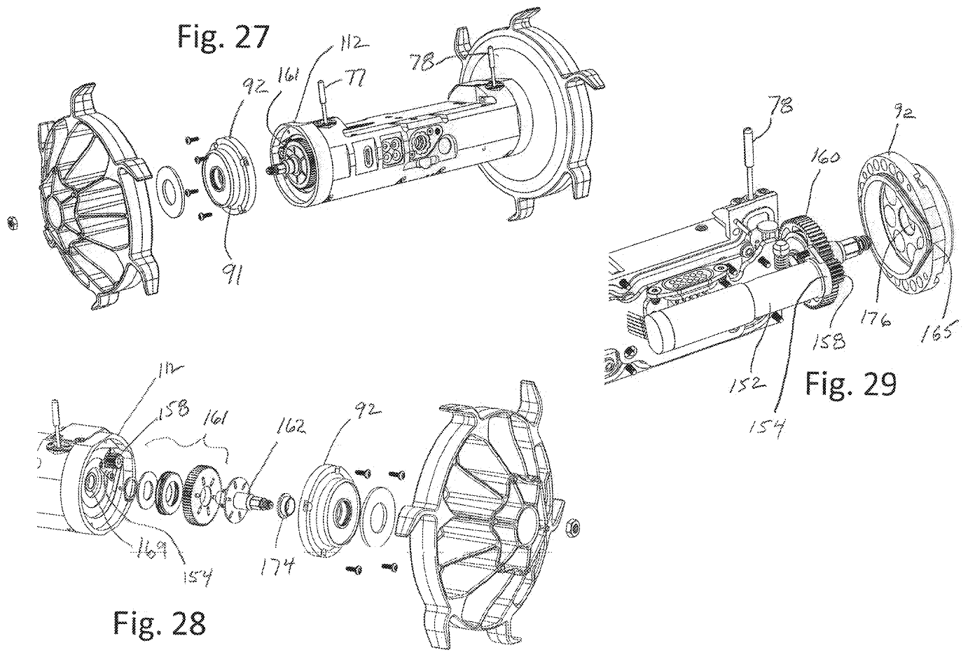

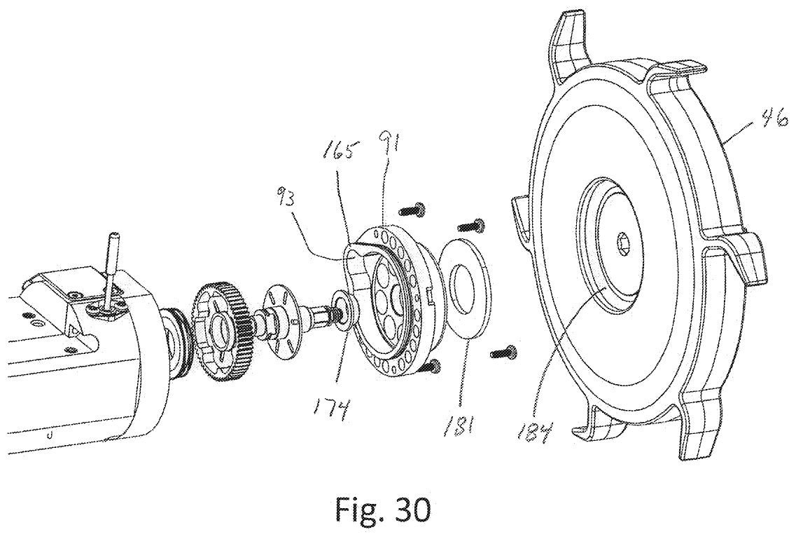

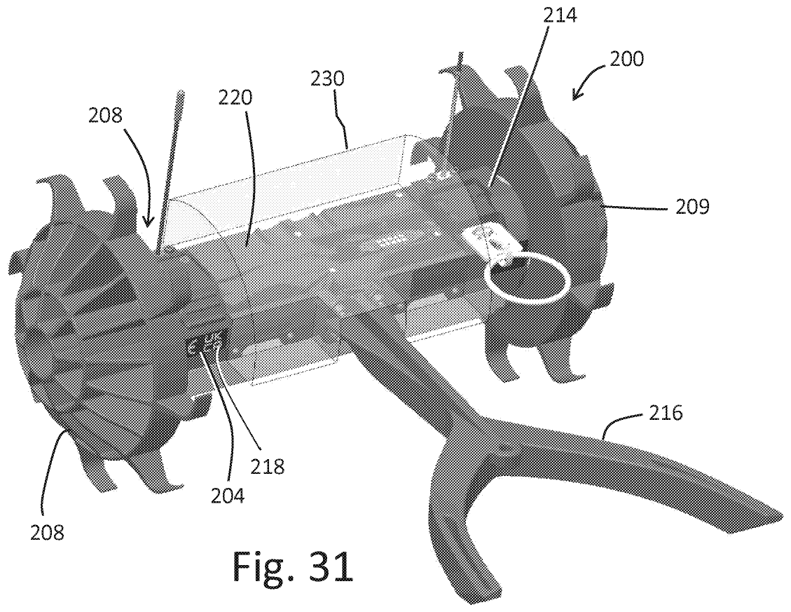

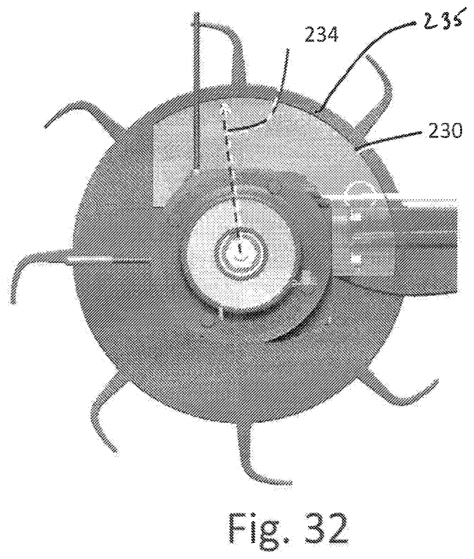

Referring to FIGS. 31-38, a robot 200 having a body 204, a pair of wheels 208, 209 at opposite ends 214 of the body, a rearwardly extending tail 216 attached to the body 204. The body 204 comprising a chassis 218, the chassis having a central recess 220 in the upper portion, and upper side of the chassis. See also recess 67 in FIGS. 25 and 26. The recess 220 positioned intermediate the ends of the body and chassis.

A protective zone 230 extending between the wheels along the body 204 is defined by a crush resistant diameter 234 of the wheels that generally correlates with the hub 235 of each wheel defining an outer periphery of the protective zone, and by the outer surfaces of the robot body 204, and by the tail 216.

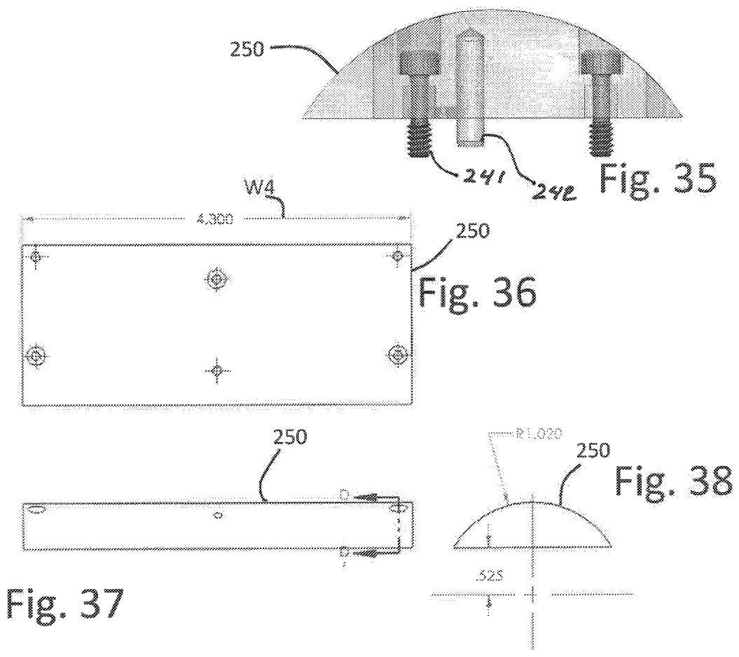

FIG. 35 depicts screws 241 and a dowel 242 that may secure the payload 250 to the upper portion of the chassis. Where the payload provides a module that includes a forward firing projectile or projectiles that effects a rearward force on the module, and consequently the connection between the robot body and the payload, such features as the dowel and/or screws may facilitate a secure connection.

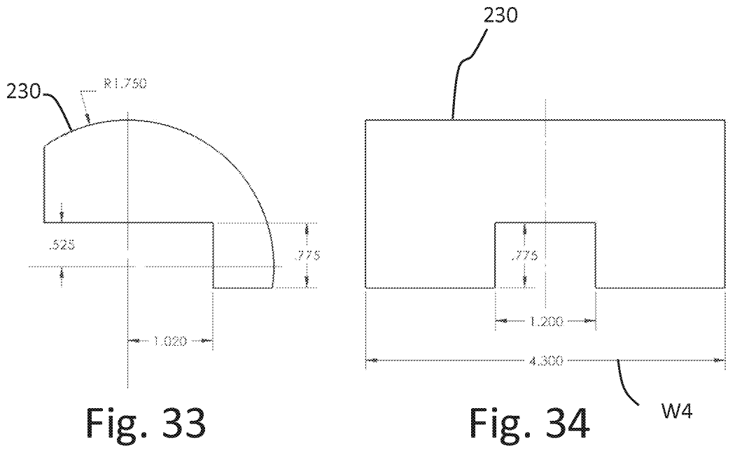

An accessory, or payload 250, in embodiments, may be shaped to be contained substantially or exclusively within the protective zone. In embodiments, the payload 250 is conformingly sized for the recess. Dimensions of a protective zone 230 are illustrated in FIGS. 33 and 34. The dimensions of the protective zone may also correlate with dimensions of payload, such as an accessory as described above, to be carried by the robot. Dimensions of payload 250 may be, for example, as illustrated in FIGS. 35-38. Dimensions in the figures are all in inches. In embodiments, these dimensions, may vary within a range that is plus or minus 10% of the given numbers. In embodiments, these dimensions, may vary within a range that is plus or minus 20% of the given numbers. In embodiments, these dimensions, may vary within a range that is plus or minus 30% of the given numbers. The payload may generally occupy the entire axially extending width W4 of the recess in the body 220, as illustrated in FIGS. 34, 36, and 37, with a snug fit or with some clearance.

Additional known two wheeled throwable robots are disclosed, for example, in U.S. D637217, U.S. Pat. Pub. US 20100152922, and U.S. Pat. No. 6,548,982. The contents of which are incorporated by reference herein.

We claim:

1. A throwable robot comprising a pair of drive wheels supported by a chassis extending between the drive wheels, the chassis having an axis extending between the wheels, a rearwardly extending tail attached to a rearward facing central portion of the chassis, the chassis defining a lower axially extending battery module recess facing downwardly for receiving a battery module, the robot further comprising a battery module secured to the chasis in said battery module recess, the battery module providing an exterior surface of the robot at a bottom side of the robot.

2. The throwable robot of claim 1, wherein the recess is an inverted U-shaped when viewed from in front of the robot.

3. The throwable robot of claim 1, wherein the chassis further defines an upwardly facing recess extending axially, the upwardly facing recess having a U-shape when viewed from in front of the robot.

4. The throwable robot of claim 3, wherein a payload is secured to the robot in the robot recess, the payload extending rearwardly and downwardly to engage a rearward face of the chassis of the robot on each of two sides of the tail of the robot.

5. The throwable robot of claim 3, wherein a payload comprising a module that fires projectiles is secured to the robot in the robot recess, the payload extending rearwardly to engage a rearward face of the chassis of the robot, and extends downwardly on each of two sides of the tail of the robot.

6. The throwable robot of claim 3, wherein operational components are attached to the chassis between the upwardly facing recess and each of the pair of drive wheels.

7. The throwable robot of claim 1, wherein the robot weighs less than 6 pounds and has an axial length of less than 14 inches.

8. A throwable robot having an elongate body positioned between two wheels, the body comprising a chassis with a central axis extending therethrough between the two wheels, the body having a pair of axially extending recesses, an upwardly facing recess and a downwardly facing recess, one of the pair of recesses for receiving a battery module and one of the pair of recesses for receiving a payload.

9. The throwable robot of claim 8, wherein the upwardly facing recess extends most of a distance between the two wheels, and the downwardly facing recess extends most of the distance between the two wheels.

10. The throwable robot of claim 9, wherein the downwardly facing recess is a battery module recess and the robot further comprises a battery module configured for the recess and the battery module having an exteriorly exposed surface when installed in the robot.

11. The throwable robot of claim 9, wherein the each of the two wheels have a central hub defining a protective zone extending therebetween along the body, and wherein the upwardly facing recess is a payload recess and the robot further comprises a payload configured for the recess and sized to be within the protective zone.

12. The throwable robot of claim 11, wherein the payload extends down a rearward side of the body on each of two sides of the attached tail.

13. The throwable robot of claim 11, wherein the payload is a munition module.

14. The throwable robot of claim 13, wherein the robot weighs less than 6 pounds and has an axial length of less than 14 inches.

15. A throwable robot having an elongate body positioned between two wheels, the body comprising a chassis with a central axis extending therethrough that defines the exterior surface of the body, the chassis having an outermost surface with a radius that is at least 1.5 inches less than an undeflected maximum radius of each of the wheels, the chassis having two circumferentially spaced axial extending recesses that each extend continuously most of the axial distance between the wheels, wherein one of the two axially extending recesses is a battery module recess conformingly shaped for a battery module, the robot further comprising an exteriorly exposed battery module.

16. The throwable robot of claim 15, wherein one of the two axially extending recesses is a top side payload or accessory recess for receiving a payload or accessories, the recess defined by a upwardly facing flat surface, an electrical connector with a plurality of contact points facing upwardly.

17. The throwable robot of claim 16, further comprising a munitions module payload the interfaces with the contact points.

18. The throwable robot of claim 15, wherein the robot further comprising circuitry that is on the one or more circuit boards that includes processing circuity and radio circuitry permitting communications with and control by a remote control unit.

19. The throwable robot of claim 15, wherein the robot weighs less than 6 pounds and has an axial length of less than 14 inches.

20. The throwable robot of claim 17, wherein the robot weighs less than 6 pounds and has an axial length of less than 14 inches.
